(19) United States
(12) Patent Application Publication
(10) Pub. No.: US 2004/0136310 A1
(43) Pub. Date: Jul. 15, 2004

(54) Drive chip integrated laser diode module and optical pickup apparatus adopting the same

(75) Inventors: Ki-Jae Park, Seoul (KR); Ju-Hyung Lee, Suwon-si (KR); Pyong-Yong Seong, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/743,902

(22) Filed: Dec. 24, 2003

(30) Foreign Application Priority Data
Dec. 27, 2002 (KR) 2002-85445

(51) Int. Cl. G11B 7/00

(52) U.S. Cl. 369/121; 369/120

(57) ABSTRACT

A drive chip integrated laser diode module including a laser diode module main body to generate and emit laser light, a plurality of first leads protruding outwardly from the laser diode module main body to receive electric power, a drive chip, a plurality of coupling holes in the drive chip in which each of the first leads is inserted, respectively, a plurality of inner connectors in the drive chip, electrically connected to each of the first leads, respectively, a plurality of second leads protruding outwardly from the drive chip, a main board, a plurality of lands provided on the main board, electrically connected to the second leads, and a through hole in the main board through which the laser diode module main body passes, wherein the drive chip and the main board are integrally formed with respect to the laser diode module main body.

### CROSS-REFERENCE TO RELATED APPLICATIONS

This application claims the priority of Korean Patent Application No. 2002-85445, filed on Dec. 27, 2002, in the Korean Intellectual Property Office, the disclosure of which is incorporated herein in its entirety by reference.

### BACKGROUND OF THE INVENTION

1. Field of the Invention

The present invention relates to a laser diode module and an optical pickup apparatus adopting the same, and, more particularly, to a drive chip integrated laser diode module in which a drive chip used to drive a laser diode is integrally formed, and an optical pickup apparatus adopting the same.

2. Description of the Related Art

In general, optical pickup apparatuses read/write information with respect to an optical recording medium in a non-contact manner by using light. The optical pickup apparatus adopts a laser diode as a light source which generates and emits light having a predetermined wavelength. A laser diode drive chip is used to control the optical output and on/off of the laser diode.

FIG. 1 is an exploded perspective view illustrating a conventional laser diode module and a drive chip.

Referring to FIG. 1, a laser diode module 3 is coupled to a predetermined position of a mobile member 1. An installation hole 1a is provided in the mobile member 1, and the laser diode module 3 is installed in the installation hole 1a.

The laser diode module 3 includes a plurality of leads 4 which are electrically connected to a drive chip 13. The leads 4 are electrically coupled to an auxiliary board 5, provided at the rear surface of the laser diode module 3, by soldering. The auxiliary board 5 is electrically connected to a main board 11 by a ribbon cable 7.

The main board 11 is installed on the upper portion of the mobile member 1 by a plurality of screws 9. The drive chip 13, which is used to drive the laser diode module 3, is mounted on the upper portion of the main board 11. The drive chip 13 includes a plurality of leads 14 and each of the leads 14 is electrically connected to a land (not shown) provided on the main board 11 by soldering.

The main board 11 is connected to the auxiliary board 5 by the ribbon cable 7. The leads 4 of the laser diode module 3 are electrically connected to the leads 14 of the drive chip 13 indirectly by a wiring provided on the main board 11.

In the above structure of coupling the conventional laser diode module and drive chip, since the distance between the laser diode module and the drive chip is long, the laser diode module and the drive chip are connected by a cable. Thus, while an electric power is applied to the laser diode, there is a possibility of being affected by external noise. Also, since the leads of the laser diode are exposed outwardly, the laser diode is susceptible to static electricity.

Further, since the mobile member and the main board are assembled in a state in which the laser diode module and the main board are separated and are electrically connected by the ribbon cable, assembly is complicated and a manufacturing cost is high.

### SUMMARY OF THE INVENTION

To solve the above and/or other problems, the present invention provides a drive chip integrated laser diode module in which a drive chip used to drive a laser diode is integrally formed so that the assembly thereof is simplified and a manufacturing cost is reduced, and an optical pickup apparatus adopting the same.

Additional aspects and/or advantages of the invention will be set forth in part in the description which follows and, in part, will be obvious from the description, or may be learned by practice of the invention.

According to an aspect of the present invention, a drive chip integrated laser diode module comprises a laser diode module main body to generate and emit laser light, a plurality of first leads protruding outwardly from the laser diode module main body to receive electric power, a drive chip, a plurality of coupling holes in the drive chip in which each of the first leads is inserted, respectively, a plurality of inner connectors in the drive chip, electrically connected to each of the first leads, respectively, a plurality of second leads protruding outwardly from the drive chip, a main board, a plurality of lands provided on the main board, electrically connected to the second leads, and a through hole in the main board through which the laser diode module main body passes, wherein the drive chip and the main board are integrally formed with respect to the laser diode module main body.

According to another aspect of the present invention, an optical pickup apparatus adopting a drive chip integrated laser diode module is provided, the optical pickup apparatus comprising: a drive chip integrated laser diode module including a laser diode module main body to generate and emit laser light, a plurality of first leads protruding outwardly from the laser diode module main body to receive electric power, a drive chip, a plurality of coupling holes in the drive chip in which each of the first leads is inserted, respectively, a plurality of inner connectors in the drive chip, electrically connected to each of the first leads, respectively, a plurality of second leads protruding outwardly from the drive chip, a main board, a plurality of lands provided on the main board, electrically connected to the second leads, and a through hole in the main board through which the laser diode module main body passes; a base to reciprocate in a radial direction of an optical recording medium, the base including an installation portion where the drive chip integrated laser diode module is installed, and an installation hole to which the laser diode module main body is coupled; a bobbin connected to the base through a suspension and movably installed in a track direction and a focus direction of the optical recording medium above the base; an objective lens mounted on the bobbin to focus light emitted from the laser diode module on the optical recording medium, a magnetic actuating unit provided across the base and the bobbin to actuate the objective lens in the track direction and the focus direction of the optical recording medium; and a photodetector provided on the base to detect an information signal and an error signal by receiving light reflected by the optical recording medium.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is an exploded perspective view illustrating a conventional laser diode module and a drive chip;

FIG. 2 is an exploded perspective view illustrating a drive chip integrated laser diode module according to an embodiment of the present invention;

FIG. 3 is a sectional view illustrating the drive chip integrated laser diode module of FIG. 2;

FIG. 4 is an exploded perspective view illustrating a state of assembling the drive chip integrated laser diode module of FIG. 2 to an optical pickup; and

FIG. 5 is a perspective view illustrating an optical pickup adopting the drive chip integrated laser diode module of FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

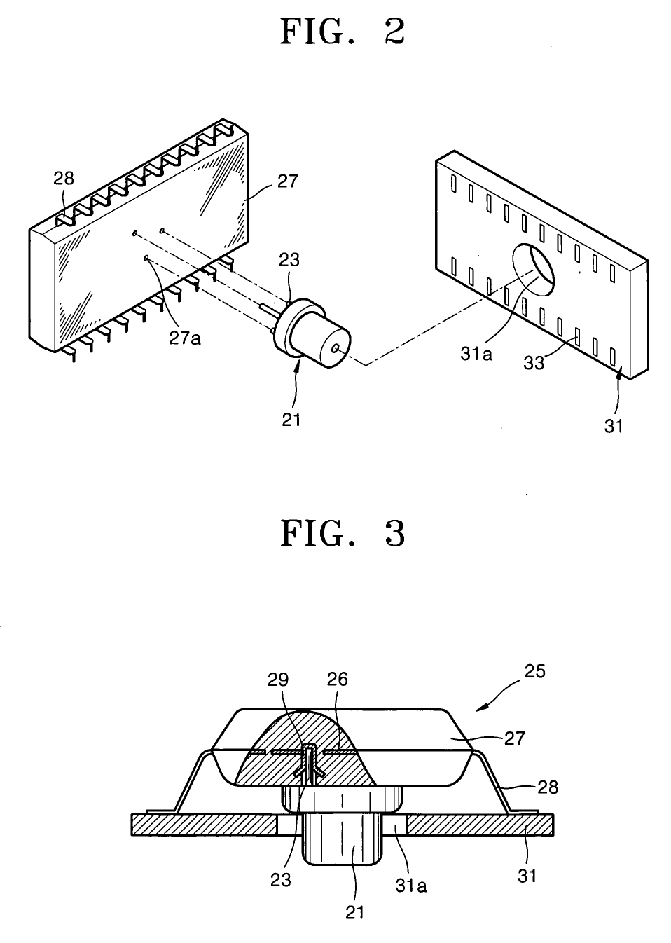

Referring to FIGS. 2 and 3, a drive chip integrated laser diode module according to an embodiment of the present invention includes a laser diode module main body 21 which generates and emits laser light, a drive chip 25 which drives the laser diode module main body 21, and a main board 31. The drive chip 25 and the main board 31 are integrally coupled with respect to the laser diode module main body 21.

The laser diode module main body 21 includes a laser diode (not shown) inside the laser diode module main body 21, and a plurality of first leads 23 protruding outwardly to apply electric power to the laser diode. Since the structure of the laser diode module main body 21 is well known in the art, a detailed description thereof is omitted.

The drive chip 25 is packaged with a mold resin 27 in a state in which a semiconductor device is mounted on a lead frame 26, and includes a plurality of second leads 28 protruding outwardly. Also, a plurality of coupling holes 27a, into which the first leads 23 are inserted, are formed in the mold resin 27. Inner connectors 29, to which each of the first leads 23 are respectively electrically connected, are formed in each of the coupling holes 27a.

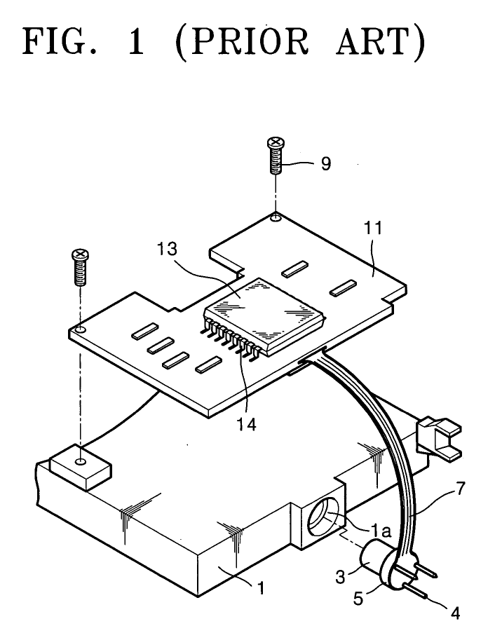

The second leads 28 are electrically connected to a plurality of lands 33 provided on the main board 31. The inner connectors 29, which correspond to the first leads 23 connected to the laser diode module main body of the conventional drive chip 13 of FIG. 1, are provided in the mold resin 27 without protruding outwardly from the coupling holes 27a. Also, the inner connectors 29 have a predetermined shape as shown in FIG. 3, so that an end portion of the first lead 23 is inserted.

The main board 31 has the lands 33 electrically connected to the second leads 28, and a through hole 31a through which the laser diode module main body 21 passes.

Thus, in a state in which the laser diode module main body 21 is coupled to the rear surface of the drive chip 25, the main board 31 is directly coupled to the rear surface of the drive chip 25 so that the structure may be made compact. Since part of the laser diode module main body 21 protrudes through the through hole 31 a provided at the main board 31, mechanical interference and optical interference can be avoided.

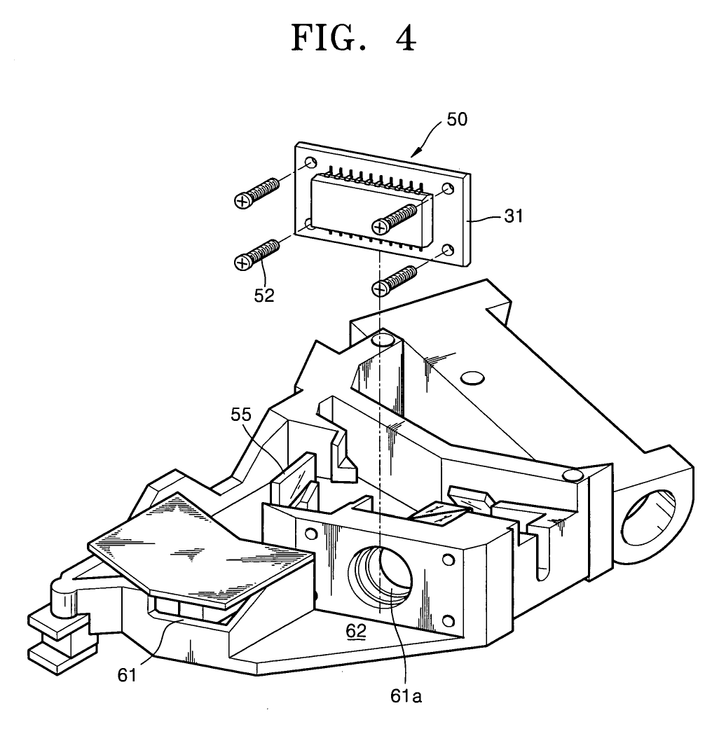

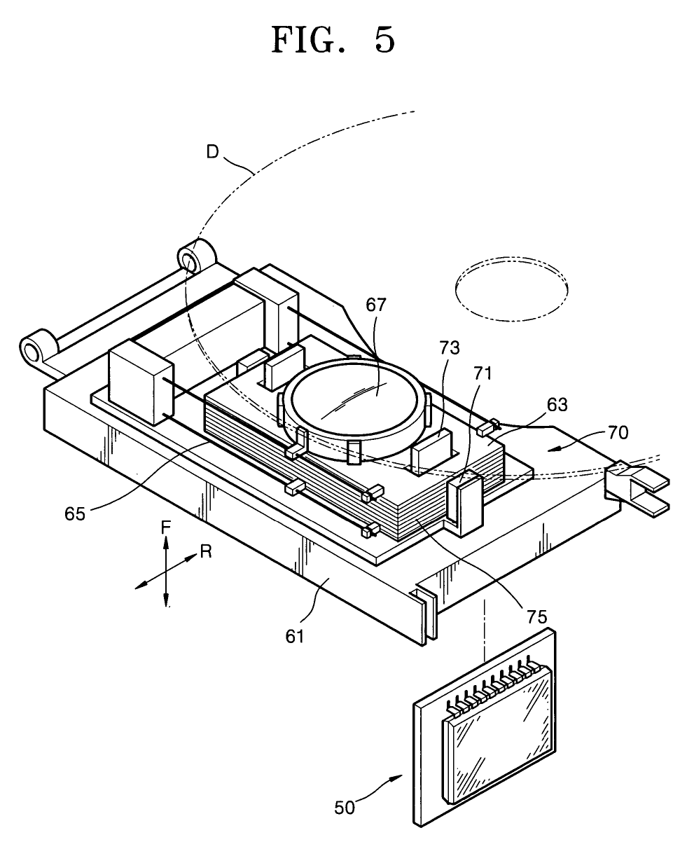

Referring to FIGS. 4 and 5, an optical pickup apparatus according to an embodiment of the present invention includes a base 61, a laser diode module 50, and a photodetector 55 provided on the base 61, a bobbin 63 movably installed on the base 61 by a suspension 65, an objective lens 67 mounted on the bobbin 63, and a magnetic actuating unit 70 which actuates the bobbin 63 with respect to the base 61.

The laser diode module 50 includes the laser diode module main body 21, the drive chip 25, and the main board 31, which are integrally formed. Since the structure and arrangement thereof are described above, a detailed description thereof is omitted.

The base 61 is movable in a radial direction of an optical recording medium D, and includes an installation portion 62 where the drive chip laser diode module 50 is installed, and an installation hole 61a formed in the base 61 which receives the laser diode module main body 21 of FIG. 2.

In installing the drive chip integrated laser diode module 50 with respect to the base 61, the main board 31 is coupled to the installation portion 62 by using a screw 52. Thus, since heat generated by the laser diode module 50 is dissipated through the screw 52 and the base 61, a heat generation problem due to the inner connectors 29 of FIG. 3 provided inside may be solved.

As another possible solution to the heat problem, the laser diode module main body 21 of FIG. 3 may be coupled in the installation hole 61a so as to contact an inner wall of the installation hole 61a provided on the base 61. In this case, the heat generated from the laser diode module 50 may be dissipated through the base 61.

The bobbin 63 is installed to be able to move by the suspension 65 above the base 61 in a track direction R and a focus direction F of the optical recording medium D. The objective lens 67 is mounted on the bobbin 63, and focuses the light emitted from the laser diode module 50 on the optical recording medium D.

The magnetic actuating unit 70 is arranged across the base 61 and the bobbin 63, and actuates the objective lens 67 in the track direction R and the focus direction F by using an electromagnetic force. The magnetic actuating unit 70 includes a magnet 71, a yoke 73, and a coil member 75. A detailed description thereof is omitted because the structure and operation thereof are well known.

The photodetector 55 may be provided on the base 61, and detects an information signal, a tracking error signal, and a focusing error signal by receiving the light reflected by the optical recording medium D.

As described above, in the drive chip integrated laser diode module according to the present invention, since the drive chip needed to drive the laser diode is integrally formed, assembly time can be reduced. Also, since the drive chip and the laser diode module are directly connected, an additional cable to connect them is not needed, so that manufacturing cost can be reduced.

Thus, in the optical pickup apparatus according to the present invention, by adopting a drive chip integrated laser diode module as a light source module, the assembly time and the manufacturing cost may be reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A drive chip integrated laser diode module comprising:
a laser diode module main body to generate and emit laser light;
a plurality of first leads protruding outwardly from the laser diode module main body to receive electric power;
a drive chip;
a plurality of coupling holes in the drive chip in which each of the first leads is inserted, respectively;
a plurality of inner connectors in the drive chip, electrically connected to each of the first leads, respectively;
a plurality of second leads protruding outwardly from the drive chip;
a main board;
a plurality of lands provided on the main board, electrically connected to the second leads; and
a through hole in the main board through which the laser diode module main body passes;
wherein the drive chip and the main board are integrally formed with respect to the laser diode module main body.

2. An optical pickup apparatus adopting a drive chip integrated laser diode module, the optical pickup apparatus comprising:
a drive chip integrated laser diode module comprising:
a laser diode module main body to generate and emit laser light,
a plurality of first leads protruding outwardly from the laser diode module main body to receive electric power,
a drive chip,
a plurality of coupling holes in the drive chip in which each of the first leads is inserted, respectively,
a plurality of inner connectors in the drive chip, electrically connected to each of the first leads, respectively,
a plurality of second leads protruding outwardly from the drive chip,
a main board,
a plurality of lands provided on the main board, electrically connected to the second leads, and
a through hole in the main board through which the laser diode module main body passes;
a base to reciprocate in a radial direction of an optical recording medium, the base comprising:
an installation portion where the drive chip integrated laser diode module is installed, and
an installation hole to which the laser diode module main body is coupled;
a bobbin connected to the base through a suspension, and movably installed in a track direction and a focus direction of the optical recording medium above the base;
an objective lens mounted on the bobbin to focus light emitted from the laser diode module on the optical recording medium;
a magnetic actuating unit provided across the base and the bobbin to actuate the objective lens in the track direction and the focus direction of the optical recording medium; and
a photodetector provided on the base to detect an information signal and an error signal by receiving light reflected by the optical recording medium.

3. The optical pickup apparatus as claimed in claim 2, wherein the drive chip integrated laser diode module is installed on the base by coupling the main board and the installation portion using a screw, and heat generated from the laser diode module main body is dissipated through the screw and the base.

4. The optical pickup apparatus as claimed in claim 2, wherein the laser diode module main body is installed in the installation hole so as to contact an inner wall of the installation hole provided in the base, and heat generated from the laser diode module main body is dissipated through the base.

5. A drive chip integrated laser diode module comprising:
a laser diode module main body to generate and emit laser light;
a drive chip to drive the laser diode module main body; and
a main board;
wherein the drive chip and the main board are integrally coupled with respect to the laser diode module main body.

6. The drive chip integrated laser diode module of claim 5, wherein the laser diode module main body comprises:
a laser diode inside the laser diode module main body; and
a plurality of laser diode leads protruding outwardly to apply electric power to the laser diode.

7. The drive chip integrated laser diode module of claim 6, wherein the drive chip is packaged with a mold resin in a state in which a semiconductor device is mounted on a lead frame.

8. The drive chip integrated laser diode module of claim 7, further comprising a plurality of coupling holes formed in the mold resin of the drive chip, wherein the plurality of laser diode leads are respectively inserted into the coupling holes.

9. The drive chip integrated laser diode module of claim 8, further comprising a plurality of inner connectors formed in each of the coupling holes, respectively, wherein each of the laser diode leads are respectively electrically connected.

10. The drive chip integrated laser diode module of claim 9, wherein the inner connectors are provided in the mold resin without protruding outwardly from the coupling holes.

11. The drive chip integrated laser diode module of claim 9, wherein the inner connectors have a predetermined shape in which end portions of the laser diode leads are inserted.

12. The drive chip integrated laser diode module of claim 5, wherein the drive chip further comprises a plurality of drive chip leads protruding outwardly.

13. The drive chip integrated laser diode module of claim 11, further comprising a plurality of lands provided on the main board, wherein the drive chip leads are electrically connected to the lands.

14. The drive chip integrated laser diode module of claim 5, further comprising a through hole in the main body through which the laser diode module main body passes.

15. The drive chip integrated laser diode module of claim 5, wherein the main board is directly coupled to a surface of the drive chip so that the structure is made compact.

16. A drive chip integrated laser diode module comprising:
a laser diode module main body to generate and emit laser light;
a drive chip to drive the laser diode module main body; and
a main board;
wherein the main board is directly coupled to the rear surface of the drive chip so that the structure is made compact.

17. An optical pickup apparatus adopting a drive chip integrated laser diode module, the optical pickup apparatus comprising:
a base to reciprocate in a radial direction of an optical recording medium; and
a drive chip integrated laser diode module comprising:
a laser diode module main body to generate and emit laser light,
a drive chip to drive the laser diode module main body, and
a main board,
wherein the main board is directly coupled to the rear surface of the drive chip so that the structure is made compact;
wherein the drive chip integrated laser diode module is coupled to the base by a heat dissipating member to dissipate heat generated by the drive chip integrated laser diode module.

18. The optical pickup apparatus of claim 17, wherein the dissipating member is a screw.

19. The optical pickup apparatus of claim 17, further comprising an installation hole in the base, wherein the laser diode module main body is contacting an inner wall of the installation hole to dissipate heat from the drive chip integrated laser diode module to the base.

20. An optical pickup apparatus adopting a drive chip integrated laser diode module, the optical pickup apparatus comprising:
a base to reciprocate in a radial direction of an optical recording medium; and
a drive chip integrated laser diode module comprising:
a laser diode module main body to generate and emit laser light,
a drive chip to drive the laser diode module main body, and
a main board,
wherein the main board is directly coupled to the rear surface of the drive chip so that the structure is made compact;
wherein the drive chip integrated laser diode module is coupled to the base so as to dissipate heat generated by the drive chip integrated laser diode module.

21. The optical pickup apparatus of claim 20, further comprising an installation hole in the base, wherein the laser diode module main body is contacting an inner wall of the installation hole to dissipate heat from the drive chip integrated laser diode module to the base.
